(19) United States
(12) Patent Application Publication
(10) Pub. No.: US 2025/0069571 A1
(43) Pub. Date: Feb. 27, 2025

(54) MOUTHPIECE OF A WIND INSTRUMENT, AN ELECTRIC HARMONICA, AN ELECTRIC BLOWPIPE, AND A WIND INSTRUMENT

(71) Applicant: RINGWAY TECH (JIANGSU) CO., LTD., JIANGSU (CN)

(72) Inventors: Ping Zhao, JIANGSU (CN); Jianping Song, JIANGSU (CN); Guobin Chen, JIANGSU (CN); Wei Zhang, JIANGSU (CN); Zonghua Yang, JIANGSU (CN)

(73) Assignee: RINGWAY TECH (JIANGSU) CO., LTD., JIANGSU (CN)

(21) Appl. No.: 18/811,885

(22) Filed: Aug. 22, 2024

Related U.S. Application Data
(60) Provisional application No. 63/578,313, filed on Aug. 23, 2023.

(51) Int. Cl. G10D 7/14

(52) U.S. Cl. CPC G10D 7/14

(57) ABSTRACT

The present utility model is a mouthpiece of a wind instrument, an electric harmonica, an electric blowpipe, and a wind instrument. The mouthpiece for a wind instrument comprises air chambers, disposed in the housing of the wind instrument; air pressure sensors, disposed at the bottom of the air chambers for detecting air pressure changes within the air chambers; an air intake channel, disposed on the outer side of the air chambers, and when air is blown into the air intake channel. The air chambers produce pressure changes which are detected by the air pressure sensors. Air vents, disposed on the air intake channel, are configured for airflow to enter the air intake channel and be discharged from the air vents, and the path thereof changes. Such a configuration can improve user comfort, reduce poor hygiene within the instrument, and reduce the chances of inadvertent sound output.

### CROSS-REFERENCES TO RELATED APPLICATIONS

This Non-Provisional Utility Patent Application claims the benefit of and priority to U.S. Provisional Patent Application Ser. No. 63/578,313, filed Aug. 23, 2023, entitled “A Mouthpiece of a Wind Instrument, an Electric Harmonica, an Electric Blowpipe, and a Wind Instrument,” the entire contents of which is hereby incorporated herein by reference.

### FIELD OF TECHNOLOGY

The present utility model relates to the technical field of musical instruments, specifically a mouthpiece of a wind instrument, an electric harmonica, an electric blowpipe, and a wind instrument.

### BACKGROUND

Electric wind instruments incorporate the airflow of gas blown into the appropriate gas channel through the blow holes on the mouthpiece. An internal control circuit board monitors the pressure value from each air pressure sensor, identifies the corresponding force of each blow hole of the mouthpiece based on the pressure value, generates corresponding MIDI command based on the identified result, synthesizes and processes the instructions through the MIDI synthesis board, and produces sounds through a sound output module.

Since the blow holes are at the outer end of the gas channel, they are directly covered by the mouth when gas is blown in, which has the following disadvantages: 1. during regular performance, the amount of gas blown out is much greater than the amount of gas entering the harmonica, so it tends to create a feeling of breath holding; 2. excess gas enters the harmonica, which tends to cause cleaning and hygiene problems; 3. when the hand or mouth presses against the blow holes before the performance starts, the air pressure changes in the harmonica tends to cause sounds to be produced by mistake, thereby affecting the performance effect. Electric harmonicas also have the following defects: the embouchure is larger than the blow holes, so some of the gas enters the blow holes from both sides during performance, causing sounds to be produced by mistake and causing sounds to mix, thereby affecting the performance effect.

Therefore, how to overcome the above defects has become an urgent problem to be solved by those skilled in the art.

### SUMMARY

In order to solve technical problems in the background art, the present utility model discloses a mouthpiece of a wind instrument, an electric harmonica, an electric blowpipe, and a wind instrument.

The present utility model provides a mouthpiece of a wind instrument, comprising
air chambers, disposed in the housing of the wind instrument;
air pressure sensors, disposed at the bottom of the air chambers for detecting air pressure changes within the air chambers;
an air intake channel, disposed on the outer side of the air chambers, and when air is blown into the air intake channel, the air chambers produce pressure changes, which are detected by the air pressure sensors;
air vents, disposed on the air intake channel, are configured for airflow to enter the air intake channel and be discharged from the air vents, and path thereof changes.

During performance, airflow enters the air chambers through the air intake channel, causing air pressure changes in the air chambers, the air pressure sensors detect the air pressure changes and generate air pressure signals, and the controller changes the air pressure signals to electrical signals, triggering the sound engine to produce sounds; the air vents have the following technical effects: 1. during performance, excess gas is directed out from the air vents in a timely manner, so as to not create a feeling of breath holding and improve comfort; 2. excess gas is discharged in a timely manner, which reduces the probability of cleaning and hygiene problems; 3. the air vents keep the air pressure in the wind instrument stable so that it does not produce sounds by mistake when the hand or mouth presses against the air intake channel before the performance starts.

The air vents have two types of structures, one type is as follows: the air vents are provided as a structure that runs through the top and bottom of the air intake channel. Specifically, parallel connecting plates are provided on the front side of the air chambers, partitions connecting the connecting plates are provided on both sides of the air chambers, and blow holes are provided on the connecting plates, thereby forming the air intake channel; air vents are provided at both ends of the through holes formed by the connecting plates, partitions, and housing.

Since the gas blown out enters the air intake channel before entering the air chambers, if the cross-sectional area of the air chamber inlet is smaller than or equal to the cross-sectional area of the blow holes, airflow into the air chambers will be insufficient, which affects the performance effect, Hence, in order to make further improvements to and resolve this issue, specifically, the blow holes are square, and cover the inlet of the air chambers.

The second type of air vents is as follows: the air vents are provided at the top and bottom of the air intake channel, and are provided as a structure that runs through the left and right of the air intake channel. Specifically, the housing is provided with grooves on one side, and the air chambers are provided at the bottom of the grooves; the grooves are provided with spacers therein to separate the air chambers; the housing is provided with symmetrically arranged cover plates at the top and bottom, which cover both ends of the grooves; the cover plates and two adjacent spacers form the air intake channel, or the cover plates, spacers and groove walls form the air intake channel; the end of the spacers, the cover plates and the housing form the air vents. Since the mouth faces the air chambers directly, most of the gas still enters the air chambers, thereby forming air pressure for the wind instrument to produce sounds.

If the air vents are too large, too much gas leaks out, affecting the sound effect of the wind instrument. If the air vents are too small, excess gas cannot be discharged in time. Hence, this problem will be further improved and resolved. Specifically, the end surface of the spacers and the end surface of the housing form a right angle; the length of the spacers is set to 12 to 13 times the length of the right angle vertical edge.

The present utility model also provides a wind instrument, comprising a mouthpiece of a wind instrument, and at least two mouthpieces are provided.

The present utility model also provides an electric harmonica, comprising a mouthpiece of a wind instrument. During performance, the lips fit the air vents at the top and bottom of the air chambers and excess gas is discharged from the air vents on both sides of the air chambers. Electric harmonicas also have the following advantages: some of the gas flows out from the air holes when some gas enters the blow holes on both sides, thereby preventing sound from mixing.

The present utility model also provides an electric blowpipe, the end thereof is provided with a mouthpiece of a wind instrument, and at least two mouthpieces are provided, and the air pressure sensors are only installed in one of the air chambers. The other blow holes are for discharging excess gas.

The present utility model also provides an electric blowpipe, the side thereof is provided with a mouthpiece of a wind instrument, and at least two mouthpieces are provided, and the air pressure sensors are only installed in one of the air chambers. The other blow holes are for discharging excess gas.

### BRIEF DESCRIPTION OF THE DRAWINGS

The present utility model is further described below with reference to the drawings and examples.

FIG. 1 is a schematic diagram of an electric harmonica;

FIG. 2 is an enlarged view at A in FIG. 1;

FIG. 3 is a top view of an electric harmonica;

FIG. 4 is a front view of an electric harmonica;

FIG. 5 is a schematic diagram of another structure of an electric harmonica;

FIG. 6 is a right cross-sectional view of another structure of an electric harmonica;

FIG. 7 is a schematic diagram of another structure of an electric harmonica with concealed cover plates;

FIG. 8 is a partial structural schematic diagram of an electric blowpipe, in which the air chambers are provided at the end;

FIG. 9 is a partial structural schematic diagram of an electric blowpipe, in which the air chambers are provided at the side;

In the figure, 1. housing; 2. air chamber; 3. air vent; 4. blow hole; 5. connecting plate; 6. partition; 7. spacer; 8. cover plate; 9. air pressure sensor; 11. groove.

### DETAILED DESCRIPTION

The present utility model is hereby further described in detail with reference to the drawings. These drawings are simplified schematic diagrams that describe the basic structure of the present utility model by way of illustration only. Therefore, they only show the composition related to the present utility model.

### Example 1

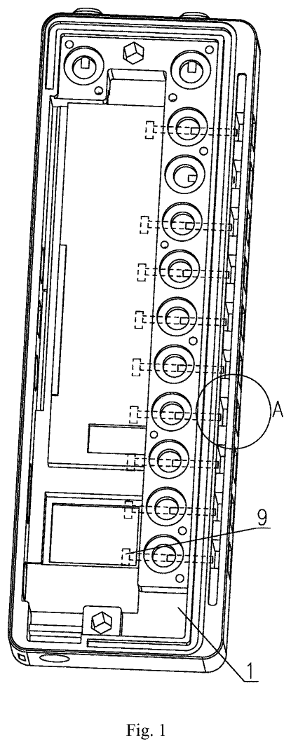

As shown in FIG. 1, the present utility model discloses an electric harmonica, comprising a housing 1. The two sides of the housing 1 that are covered by the lips are the top and bottom, and the handheld portion are the left and right sides.

The housing 1 is provided with 10 air chambers 2 that are arranged in parallel. Other examples may be provided with 20, 24, or 48 air chambers 2. The bottom of the air chambers 2 is installed with air pressure sensors 9 for detecting air pressure changes within the air chambers 2.

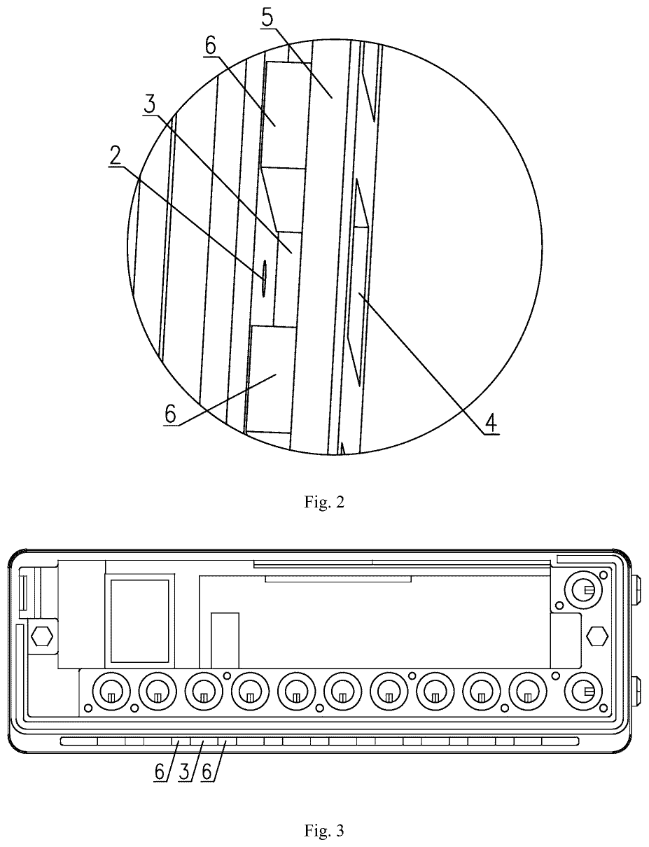

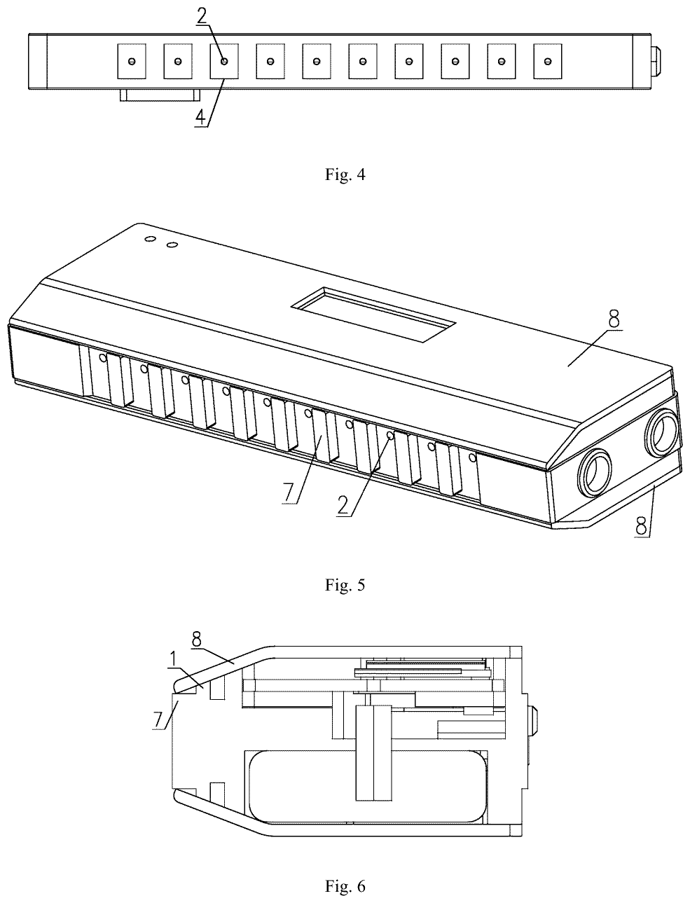

The outer side of the air chambers 2 is connected to the air intake channel. When air is blown into the air intake channel, the air chambers 2 produce pressure changes, which are detected by the air pressure sensors 9. Air vents 3 are provided on the air intake channel, and run through the top and bottom of the air intake channel. The specific structure of the air intake channel is as follows: as shown in FIG. 2 to 4, parallel connecting plates 5 are provided on the front side of the air chambers 2, partitions 6 connecting the connecting plates are provided on both sides of the air chambers 2, and blow holes 4 are provided on the connecting plate 5, thereby forming an air intake channel. Air vents (3) are provided at both ends of the through holes formed by the connecting plates (5), partitions (6), and housing (1). With this setting, the upper and lower lips may block the air vents 3 during performance, thereby allowing most of the gas to enter the housing 1.

During performance, airflow enters the air chambers 2 from the air intake channel, causing air pressure changes in the air chambers, the air pressure sensors detect the air pressure changes and generate air pressure signals, and the controller changes the air pressure signals to electrical signals, triggering the sound engine to produce sounds; the air vents 3 have the following technical effects: 1. when some gas enters the air intake channel on both sides, they flow out of the air vents 3, thereby preventing sound from mixing; 2. during performance, excess gas is directed out from the air vents 3 in a timely manner, so as to not create a feeling of breath holding and improve comfort; 3. excess gas is discharged in a timely manner, which reduces the probability of cleaning and hygiene problems; 4. the air vents keep the air pressure in the wind instrument stable so that it does not produce sounds by mistake when the hand or mouth presses against the blow holes 4 before the performance starts.

### Example 2

Compared with Example 1, the differences are as follows: the blow holes 4 are square and cover the inlet of the air chambers 2. As such, the cross-sectional area of the blow holes 4 is larger than the cross-sectional area of the inlet of the air chambers 2. Hence, when the gas blown out enters the air intake channel before entering the air chambers 2, airflow into the air chambers 2 will be sufficient, thereby ensuring a stable performance effect.

### Example 3

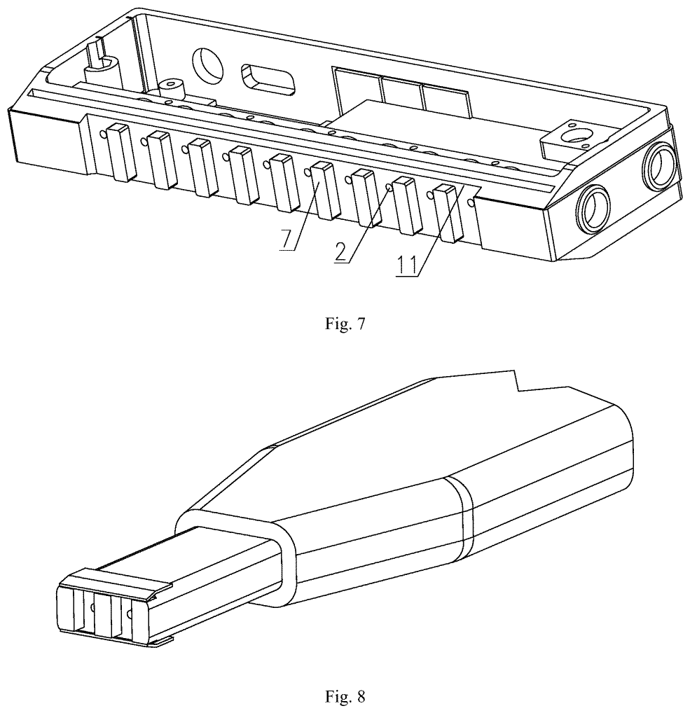

Compared with Example 1, the differences are as follows: as shown in FIG. 5 to 7, the air vents 3 are provided at the top and bottom of the air intake channel, and are provided as a structure that runs through the left and right of the air intake channel. Specifically, grooves 11 are provided on one side of the housing 1, and the air chambers 2 are provided at the bottom of the grooves 11. The grooves are provided with spacers 7 therein to separate the air chambers 2. The housing 1 is provided with symmetrically arranged cover plates 8 at the top and bottom, which cover both ends of the grooves 11. The spacers 7 are connected to the bottom of the grooves 11, the length thereof is shorter than the length of the grooves 11, making the end of the spacers 7 lower than the end of the grooves 11; the end surface of the spacers 7 and the bottom of the grooves form a right angle.

The middle air intake channel is formed by the cover plates 8 and two adjacent spacers 7, and the air intake channel at both ends are formed by the cover plates 8, spacers 7, and groove 11 walls. The end of the spacers 7, the cover plates 8 and the bottom of the grooves 11 form the air vents 3. Since the mouth faces the air chamber 2 directly, most of the gas still enters the air chamber 2, thereby forming air pressure for the wind instrument to produce sounds.

### Example 4

Compared with Example 3, the differences are as follows: the length of the spacers 7 is set to 12 to 13 times the right angle vertical edge length. This prevents the air vents 3 from being too large, allowing too much gas to leak out, affecting the sound effect of the wind instrument; this prevents the air vents 3 from being too small, failing to discharge excess gas in a timely manner.

### Example 5

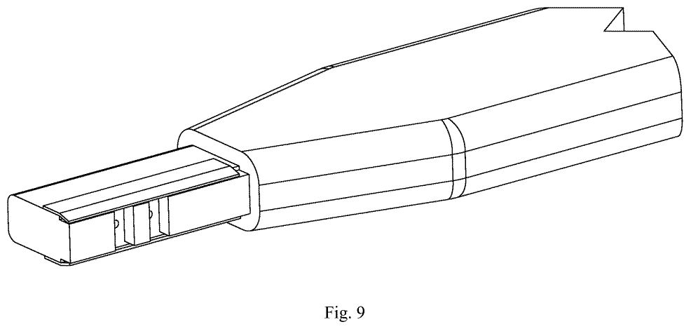

As shown in FIG. 8, the present utility model also discloses an electric blowpipe, comprising a housing 1. The two sides of the housing 1 that are covered by the lips are the top and bottom, and the handheld portion are the left and right sides.

Air chambers 2 are provided at the end of the housing 1, and air pressure sensors 9 is installed at the bottom thereof. One or both sides of the air chambers 2 are also provided with an air chamber 2, and air pressure sensors 9 are not installed at the bottom of the air chambers 2.

Grooves 11 are provided at the end of the housing 1, and the air chambers 2 are provided at the bottom of the grooves 11. The grooves are provided with spacers 7 therein to separate the air chambers 2. The housing 1 is provided with symmetrically arranged cover plates 8 at the top and bottom, which cover both ends of the grooves 11. The spacers 7 are connected to the bottom of the grooves 11, the length thereof is shorter than the length of the grooves 11, making the end of the spacers 7 lower than the end of the grooves 11; the end surface of the spacers 7 and the bottom of the grooves form a right angle.

The air intake channel is formed by the cover plates 8, spacers 7, and groove 11 walls. The end of the spacers 7, the cover plates 8 and the bottom of the grooves 11 form the air vents 3. Since the mouth faces the air chamber 2 directly, most of the gas still enters the air chamber 2, thereby forming air pressure for the wind instrument to produce sounds.

### Example 5

Compared with Embodiment 4, the differences are as follows: as shown in FIG. 9, air chambers 2 are provided at the side of the housing 1.

Based on the revelations of the above ideal examples of the present utility model, people skilled in the relevant art are capable of making various changes and modifications to the above description without departing from the technical idea of the present utility model. The technical scope of the present utility model is not limited to the content in the Specification, and the technical scope must be determined according to the scope of the Claims.

1. A mouthpiece for playing a wind instrument, wherein comprising
air chambers, disposed in the housing of the wind instrument;
air pressure sensors, disposed at the bottom of the air chambers for detecting air pressure changes within the air chambers;
an air intake channel, disposed on the outer side of the air chambers, and when air is blown into the air intake channel, the air chambers produce pressure changes, which are detected by the air pressure sensors;
air vents, disposed on the air intake channel, are configured for airflow to enter the air intake channel and be discharged from the air vents, and the path thereof changes.

2. The mouthpiece of claim 1, wherein the air vents are provided as a structure that runs through the top and bottom of the air intake channel.

3. The mouthpiece of claim 2, wherein parallel connecting plates are provided on the front side of the air chambers and partitions connecting the connecting plates are provided on both sides of the air chambers, and blow holes are provided on the connecting plates, thereby forming the air intake channel;
air vents are provided at both ends of the through holes formed by the connecting plates, partitions, and housing.

4. The mouthpiece of claim 3, wherein blow holes are square and cover the inlet of the air chambers.

5. The mouthpiece of claim 1, wherein the air vents are provided at the top and bottom of the air intake channel, and are provided as a structure that runs through the left and right of the air intake channel.

6. The mouthpiece of claim 5, wherein the housing is provided with grooves on one side, and the air chambers are provided at the bottom of the grooves;
the grooves are provided with spacers therein to separate the air chambers;
symmetrically arranged cover plates are provided at the top and bottom of the housing, and the cover plates cover both ends of the grooves;
the air intake channel is formed by the cover plates and two adjacent spacers, or the cover plates, spacers and groove walls; and
the air vents are from by the end of the spacers, the cover plates and the housing.

7. The mouthpiece of claim 6, wherein the end surface of the spacers and the end surface of the housing form a right angle; the length of the spacers is set to 12 to 13 times the length of the right angle vertical edge.

8. The mouthpiece of claim 7, wherein the wind instrument includes least two mouthpieces.

9. The mouthpiece of claim 7, wherein the wind instrument is an electric harmonica.

10. The mouthpiece of claim 7, wherein the wind instrument is an electric blowpipe and at least two mouthpieces are provided, and wherein the air pressure sensors are only installed in one of the air chambers.
